(19) United States
(12) Patent Application Publication
(10) Pub. No.: US 2004/0248005 A1
(43) Pub. Date: Dec. 9, 2004

(54) Negative electrodes including highly active, high surface area hydrogen storage material for use in electrochemical cells

(76) Inventors: Stanford R. Ovshinsky, Bloomfield Hills, MI (US); Srinivasan Venkatesan, Southfield, MI (US); Hong Wang, Troy, MI (US); Boyko Aladjov, Rochester Hills, MI (US); Meera Vijan, West Bloomfield, MI (US); Subhash K. Dhar, Bloomfield, MI (US)

Correspondence Address: ENERGY CONVERSION DEVICES, INC., 2956 WATERVIEW DRIVE, ROCHESTER HILLS, MI, 48309, US

(21) Appl. No.: 10/453,913

(22) Filed: Jun. 3, 2003

(51) Int. Cl. H01M 4/38; C22C 28/00; C22C 16/00; C22C 14/00

(52) U.S. Cl. 429/218.2; 420/900

(57) ABSTRACT

An active material for a negative electrode used in an electrochemical cell comprising a highly active, high surface area hydrogen storage material alloy which provides for high power output, fast activation, increased cycle life, and a hydrogen precharge in-situ. The highly active, high surface area hydrogen storage material is formed by first forming an alloy of a hydrogen storage alloy and aluminum and leaching the aluminum out of the alloy.

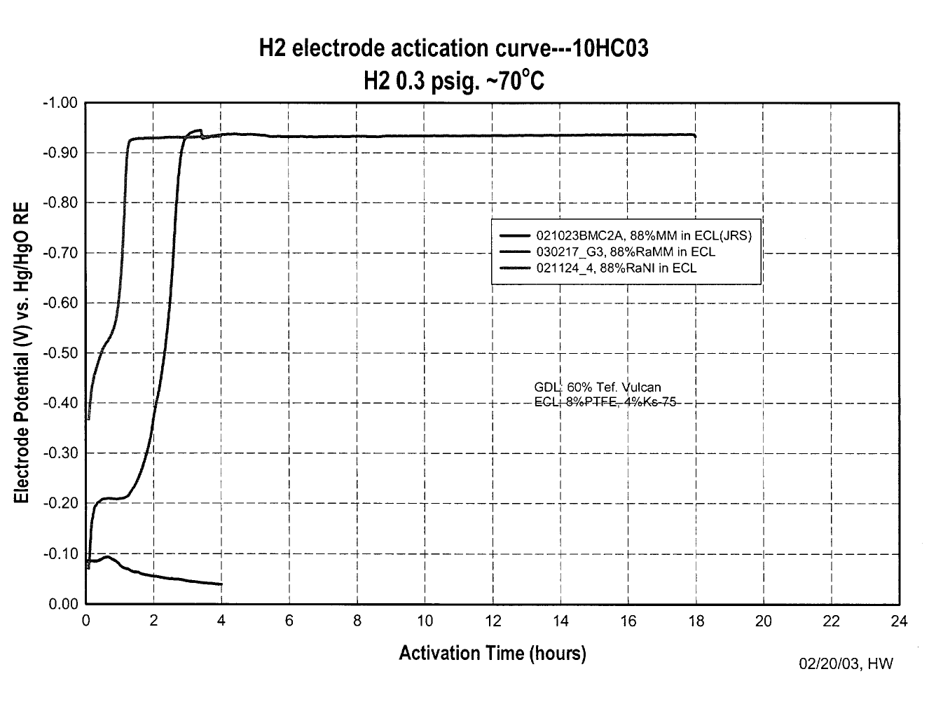

### FIELD OF THE INVENTION

The present invention generally relates to negative electrodes utilized in fuel cells and nickel metal hydride batteries. More particularly, the present invention relates to utilizing highly active, high surface area hydrogen storage material in fuel cell and nickel metal hydride battery negative electrodes.

### BACKGROUND

Negative electrodes including hydrogen storage alloys are widely used in nickel metal hydride batteries and fuel cells. Hydrogen storage alloys are useful because of their ability to store and release hydrogen within the electrochemical cell allowing for high power output and in the case of fuel cells, instant start-up capability.

A fuel cell is an energy-conversion device that directly converts the energy of a supplied gas into electric energy. Researchers have been actively studying fuel cells to utilize the fuel cell's potential high energy-generation efficiency. Fuel cells have many potential applications such as supplying power for transportation vehicles, replacing steam turbines and power supply applications of all sorts. Despite their seeming simplicity, many problems have prevented the widespread usage of fuel cells.

Presently most of the fuel cell R & D focus is on P.E.M. (Proton Exchange Membrane) fuel cells. The P.E.M. fuel cell suffers from relatively low conversion efficiency and has many other disadvantages. For instance, the proton exchange membrane (PEM) used in these cells is acidic in nature. Thus, noble metal catalysts are the only practically useful active materials for the electrodes used in the system. Unfortunately, not only are the noble metals costly, they are also susceptible to poisoning by many gases, and specifically carbon monoxide (CO). The proton exchange membrane itself is quite expensive, and because of its low conductivity, inherently limits the power performance and operational temperature range of the P.E.M. fuel cell (the P.E.M. is nearly non-functional at low temperatures). Also, the membrane is sensitive to high temperatures, and begins to soften at 120° C. The membrane's overall conductivity strongly depends on water content and dries out at higher temperatures, thus causing cell performance degradation. Therefore, there are many disadvantages to the P.E.M. fuel cell, which make it somewhat undesirable for commercial/consumer use.

The conventional alkaline fuel cell has some advantages over P.E.M. fuel cells in that they have higher operating efficiencies, they use less expensive materials of construction, and they have no need for expensive membranes. The alkaline fuel cell also has relatively higher ionic conductivity in the electrolyte, therefore it has a much higher power output capability. Unfortunately, conventional alkaline fuel cells still suffer from certain disadvantages. For instance, conventional alkaline fuel cells still use expensive noble metals catalysts in both electrodes, which, as in the P.E.M. fuel cell, are susceptible to gaseous contaminant poisoning. While the conventional alkaline fuel cell is less sensitive to temperature than the P.E.M. fuel cell, the active materials of conventional alkaline fuel cell electrodes become very inefficient at low temperatures.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources, such as combustion engines, based upon the Carnot cycle.

The major components of a typical fuel cell are the hydrogen electrode for hydrogen oxidation and the oxygen electrode for oxygen reduction, both being positioned in a cell containing an electrolyte (such as an alkaline electrolytic solution). Typically, the reactants, such as hydrogen and oxygen, contact a porous hydrogen electrode and oxygen electrode. The reactants are dissociated and migrate through the electrodes and are brought into surface contact with the electrolytic solution. The particular materials utilized for the hydrogen electrode and oxygen electrode are important since they must act as efficient catalysts for the reactions taking place.

In an alkaline fuel cell, the reaction at the hydrogen electrode (negative electrode) occurs between hydrogen fuel and hydroxyl ions (OH⁻) present in the electrolyte, which react to form water and release electrons:

H₂+2OH⁻→2H₂O+2e⁻.

At the oxygen electrode, oxygen, water, and electrons react in the presence of the oxygen electrode catalyst to reduce the oxygen and form hydroxyl ions (OH⁻):

O₂+2H₂O+4e⁻→4OH⁻.

The flow of electrons is utilized to provide electrical energy for a load externally connected to the hydrogen and oxygen electrodes.

The catalyst in the hydrogen electrode of the alkaline fuel cell has to not only split molecular hydrogen to atomic hydrogen, but also oxidize the atomic hydrogen to release electrons. The overall reaction can be seen as (where M is the catalyst):

M+H₂→2MH→M+2H⁺+2e⁻.

Thus the hydrogen electrode catalyst must efficiently dissociate molecular hydrogen into atomic hydrogen. In the case of an electrode using conventional hydrogen electrode material, the dissociated hydrogen atoms are transitional, thus the hydrogen atoms can easily recombine to form molecular hydrogen if they are not used very quickly in the oxidation reaction. With the hydrogen storage electrode materials of the inventive instant startup fuel cells, the atomic hydrogen is immediately captured and stored in hydride form, and then used as needed to provide power.

The negative electrodes used in nickel metal hydride (NiMH) batteries operate similarly to the negative electrodes used in fuel cells. In general, nickel-metal hydride (Ni-MH) cells utilize a negative electrode comprising a metal hydride active material that is capable of the reversible electrochemical storage of hydrogen. Examples of metal hydride materials are provided in U.S. Pat. Nos. 4,551,400, 4,728,586, and 5,536,591 the disclosures of which are incorporated by reference herein. Ni-MH cells typically use a positive electrode having nickel hydroxide as the active material. Examples of possible nickel hydroxide materials are provided in U.S. Pat. Nos. 5,348,822, 5,637,423,and 6,086,843 the disclosure of which are herein incorporated by reference. The negative and positive electrodes are spaced apart in an alkaline electrolyte such as potassium hydroxide.

Upon application of an electrical current across a NiMH cell, an electrochemical water discharge reaction takes place producing atomic hydrogen that gets absorbed by the hydrogen storage material of the negative electrode thus charging the negative electrode. The hydrogen ion combines with one electron and diffuses into the bulk of the hydrogen storage alloy. This reaction is reversible. Upon discharge, the stored hydrogen is released to form a water molecule and release an electron. This is shown in equation (1):

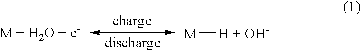

The negative electrode reactions are reversible. Upon discharge, the stored hydrogen is released from the metal hydride to form a water molecule and release an electron. The reactions that take place at the nickel hydroxide positive electrode of a Ni-MH battery cell are shown in equation (2):

Ni(OH)₂+OH⁻⇄NiOOH+H₂O+e⁻ (2)

The performance of the negative electrodes may be improved by increasing the porosity of the electrodes. High porosity within the electrodes promotes accessibility of the reactants to the active catalytic centers within the negative electrode active material. Where the accessibility of the reactants to the active catalytic centers is high, the catalytic centers per unit area is increased resulting in very active hydrogen absorption and desorption.

Typically, the performance of any electrochemical cell is significantly reduced at high discharge/charge currents. This reduction may be overcome by decreasing the current density within the negative electrodes of the electrochemical cell. Current density can be decreased by increasing the surface area by several orders of magnitude by repeated heat treatments or a combination of heat treatments and minicycles. This results in low activation polarization which achieves high specific power values with an inherently low current density. The heat treatments and minicycles, however, have an enormous process time and cause a loss in the cycle life of the electrode.

During preparation, negative electrodes may be partially oxidized to make safe for material handling and construction of the electrodes. Prior to operation, the oxide layer is removed thus activating the electrode. The activation of the negative electrodes may require a substantial amount of time. Currently, many fuel cell negative electrodes based on metal hydride catalysts require longer than 16 hours of activation at room temperature, which is unacceptable for the manufacturing cost point of view. The need for long activation time is based on the need to dissolve or leach out soluble oxides and/or reduce oxide layers and create a porous oxide structure. By increasing the porosity of the electrode, the activation time may be significantly reduced.

With the increasing applications for fuel cells and Ni-MH batteries at room temperature such as portable power and hybrid vehicle applications, fuel cells and batteries must be designed to overcome these shortfalls within the prior art. By achieving low polarization within the negative electrode active material without resorting to heat treatment and minicycles, high power output and fast activation may be achieved without a long process time and loss in cycle life. There remains a need for high porosity, high surface area negative electrode active material that provides for very fast and reversible hydrogen storage kinetics resulting in fast activation and high power output in both fuel cells and NiMH batteries.

### SUMMARY OF THE INVENTION

Disclosed in a first embodiment of the present invention is a negative electrode for an alkaline electrochemical cell formed by the process of 1) forming an alloy including at least one hydrogen storage alloy and aluminum, 2) incorporating the alloy into a negative electrode active composition, 3) forming the negative electrode from the negative electrode active composition, and 4) leaching out the aluminum from the negative electrode active composition. The hydrogen storage alloy and aluminum may be present in a ratio ranging from 10:1 to 1:10 within the alloy. Preferably, the hydrogen storage alloy and aluminum are present in a ratio of 1:1 within the alloy. The hydrogen storage material included in the alloy may be selected from Rare-earth/Misch metal alloys, zirconium alloys, titanium alloys, and mixtures or alloys thereof which may be AB, AB₂, or AB₅ type alloys.

The negative electrode active composition generally comprises 0.0 to 94 weight percent of a hydrogen storage material, 1.0 to 95 weight percent of the alloy, 3.0 to 9.0 weight percent of a binder material, and 2.0 to 5.0 weight percent of a conductive material. The negative electrode active composition may further comprise sodium borohydride. The conductive material may be selected from carbon, nickel, copper, copper plated nickel, and mixtures thereof. The negative electrode may be used in either a nickel metal hydride battery or a fuel cell.

Disclosed in a second embodiment of the present invention is a negative electrode for an alkaline electrochemical cell formed by the process of 1) forming an alloy including a hydrogen storage alloy and aluminum, 2) leaching out the aluminum from the alloy thereby forming a highly active, high surface area hydrogen storage material, 3) incorporating the highly active, high surface area hydrogen storage material into a negative electrode active composition, and 4) forming the negative electrode from the negative electrode active composition. The hydrogen storage alloy and aluminum may be present in a ratio ranging from 10:1 to 1:10 within the alloy. Preferably, the hydrogen storage alloy and aluminum are present in a ratio of 1:1 within the alloy. The hydrogen storage alloy included in the alloy may be selected from Rare-earth/Misch metal alloys, zirconium alloys, titanium alloys, and mixtures or alloys thereof which may be AB, AB₂, or AB₅ type alloys.

The negative electrode active composition generally comprises 0.0 to 94 weight percent of a hydrogen storage material, 1.0 to 95 weight percent of the highly active, high surface area hydrogen storage material, 3.0 to 9.0 weight percent of a binder material, and 2.0 to 5.0 weight percent of a conductive material. The negative electrode active composition may further comprise sodium borohydride. The conductive material may be selected from carbon, nickel, copper, copper plated nickel, and mixtures thereof. The negative electrode may be used in either a nickel metal hydride battery or a fuel cell.

Disclosed in a third embodiment of the present invention is an active material composition for a negative electrode comprising a highly active, high surface area hydrogen storage material formed by leaching aluminum out of an alloy including at least one hydrogen storage alloy and aluminum. The hydrogen storage alloy and aluminum may be present in a ratio ranging from 10:1 to 1:10 within the alloy. Preferably, the hydrogen storage alloy and aluminum are present in a ratio of 1:1 within the alloy. The hydrogen storage alloy included in the alloy may be selected from Rare-earth/Misch metal alloys, zirconium alloys, titanium alloys, and mixtures or alloys thereof which may be AB, AB₂, or AB₅ type alloys.

The active material composition may further comprise a hydrogen storage material, a binder material, sodium borohydride, and/or a conductive material selected from carbon, nickel, copper, copper plated nickel, and mixtures thereof.

### DETAILED DESCRIPTION OF THE INVENTION

The present invention discloses high performance negative electrodes for use in negative electrodes of electrochemical cells, such as fuel cells or rechargeable batteries. The negative electrodes are composed of a negative electrode active material which promotes very active hydrogen storage within the negative electrodes resulting in high power output due to increased rate and increased discharge capacity. The negative electrode active material increases rate and discharge capacity by lowering the polarization within the negative electrode via increased porosity and surface area. Increased porosity within the negative electrode allows the reactants to have increased accessibility to catalytic particles embedded within the negative electrode. Increased surface area within the negative electrode significantly improves cell performance by lowering the current density. The negative electrode active material also provides for fast activation, improved cycle life, and a hydrogen precharge in-situ.

The negative electrode active material in accordance with the present invention comprises a highly active, high surface area hydrogen storage material. The highly active, high surface area hydrogen storage material is formed by etching an alloy including a hydrogen storage material and aluminum with an alkaline electrolyte solution. The ratio of the hydrogen storage material to aluminum may range from 10:1 to 1:10. Preferably the ratio of the hydrogen storage material to aluminum is 1:1. The hydrogen storage alloy may be one or more alloys chosen from Rare-earth/Misch metal alloys, zirconium alloys, titanium alloys, and mixtures or alloys thereof. Such alloys may be of the AB, AB₂, or the AB₅ type. Upon initial contact with an alkaline electrolyte, the aluminum is leached out of the alloy leaving behind highly catalytic hydrogen storage material having a high surface area.

The highly active, high surface area hydrogen storage material may be incorporated into the negative electrode active material using two different techniques. In the first technique, an alloy including a hydrogen storage material and aluminum is formed and the aluminum is leached out of the alloy with an alkaline solution thereby forming a highly active, high surface area hydrogen storage material. When the aluminum is leached out, as a side product of the chemical reaction, hydrogen gas is formed and provides an in-situ precharge to the hydrogen storage material. The highly active, high surface area hydrogen storage material is then incorporated into the negative electrode active material and formed into a negative electrode. The second technique is to incorporate the alloy including a hydrogen storage material and aluminum into the negative electrode active material, form the negative electrode with the negative electrode active material, and introduce the negative electrode to alkaline electrolyte in the electrochemical cell. Upon contacting the alkaline solution, the aluminum is leached out leaving behind highly active, high surface area active catalytic material in-situ. This may be accomplished by contacting the negative electrode with an alkaline solution before placing it into an electrochemical cell, or by contacting the negative electrode with alkaline solution within the electrochemical cell. In the second technique whereby the aluminum is leached out of the alloy after the alloy is incorporated in the negative electrode, the leaching out of the aluminum increases the porosity of the negative electrode. The leaching operation is a corrosion reaction where the anodic reaction is the corrosion of aluminum and the cathodic reaction is hydrogen evolution. The hydrogen formed by the leaching process will be absorbed by the metal hydride matrix thereby raising the state of hydrogen charge within the negative electrode. When used in fuel cells and batteries, the increased porosity within the negative electrode allows for a faster activation time for the negative electrode and provides accessibility to catalytic particles, such as nickel, incorporated in the negative electrode active material.

The highly active, high surface area hydrogen storage material may also include nickel to increase performance of the negative electrode. In such case, the nickel is mixed with the hydrogen storage material/aluminum alloy prior to the aluminum being leached out of the alloy. After the aluminum is leached out of the alloy, the nickel forms a finely divided, highly catalytic nickel particulate within the highly active, high surface area hydrogen storage material. The high porosity of the highly active, high surface area hydrogen storage material provides accessibility of the reactants to the highly catalytic nickel particles resulting in enhanced operation of the negative electrode.

The negative electrode active material in accordance with the present invention generally comprises 0.0 to 94 weight percent of a hydrogen storage alloy, 1.0 to 95 weight percent of the highly active, high surface area hydrogen storage material, 3.0 to 9.0 weight percent of binder material, and 2.0 to 5.0 weight percent of a conductive material.

The negative electrode, may be coated with a layer of sodium borohydride distributed on the negative electrode surface at 1.0 to 3.0 milligrams per 1.0 cm². The sodium borohydride allows for faster activation upon initial use in fuel cells and batteries. The use of sodium borohydride in a negative electrode and the benefits thereof are disclosed in U.S. patent application Ser. No. 09/999,393 to Ovshinsky et al., filed Oct. 29, 2002 entitled “ACTIVE MATERIAL FOR FUEL CELL ANODES INCORPORATING AN ADDITIVE FOR PRECHARGING/ACTIVATION THEREOF”, the disclosure of which is herein incorporated by reference.

The preferable hydrogen storage alloy as used in the negative electrode active material and/or the active catalytic material is one which can reversibly absorb and release hydrogen irrespective of the hydrogen storage capacity and has the properties of a fast hydrogenation reaction rate, a good stability in the electrolyte and a long shelf-life. It should be noted that, by hydrogen storage capacity, it is meant that the material stores hydrogen in a stable form, in some nonzero amount higher than trace amounts. Preferred materials will store about 0.1 weight % hydrogen or more. Preferably, the alloys include, for example, AB₅ (rare-earth/Misch metallic) alloys, or AB₂ (zirconium and/or titanium alloys) or mixtures thereof.

The instant inventors have found that certain hydrogen storage materials are exceptionally useful as alkaline fuel cell anode materials. The useful hydrogen storage alloys have excellent catalytic activity for the formation of hydrogen ions from molecular hydrogen and also have superior catalytic activity toward the formation of water from hydrogen ions and hydroxyl ions. In addition to having exceptional catalytic capabilities, the materials also have outstanding corrosion resistance toward the alkaline electrolyte of the fuel cell. In use, the alloy materials act as 1) a molecular hydrogen decomposition catalyst throughout the bulk of the anode; 2) as a water formation catalyst, forming water from hydrogen and hydroxyl ions (from the aqueous alkaline electrolyte) at surface 6 of the anode; and 3) as an internal hydrogen storage buffer to insure that a ready supply of hydrogen ions is always available at surface 6 ( this capability is useful in situations such as fuel cell startup and regenerative energy recapture, discussed herein below).

Specific alloys useful as the anode material are alloys that contain enriched catalytic nickel regions of 50-70 Angstroms in diameter distributed throughout the oxide interface which vary in proximity from 2-300 Angstroms preferably 50-100 Angstroms, from region to region. As a result of these nickel regions, the materials exhibit significant catalysis and conductivity. The density of Ni regions in the alloy of the '591 patent provides powder particles having an enriched Ni surface. The most preferred alloys having enriched Ni regions are alloys having the following composition:

(Base Alloy)ₐCo_{b}Mn_{c}Fe_{d}Snₑ

where the Base Alloy comprises 0.1 to 60 atomic percent Ti, 0.1 to 40 atomic percent Zr, 0 to 60 atomic percent V, 0.1 to 57 atomic percent Ni, and 0 to 56 atomic percent Cr; b is 0 to 7.5 atomic percent; c is 13 to 17 atomic percent; d is 0 to 3.5 atomic percent; e is 0 to 1.5 atomic percent; and a+b+c+d+e=100 atomic percent.

The binder materials may be any material, which binds the active material together to prevent degradation of the electrode during its lifetime. Binder materials should be resistant to the conditions present within the electrochemical cells. Examples of binder materials, which may be added to the active composition, include, but are not limited to, polymeric binders such as polyvinyl alcohol (PVA), fluoropolymers, carboxymethyl cellulose (CMC), hydroxycarboxymethyl cellulose (HCMC), and mixtures thereof. An example of a fluoropolymer is polytetrafluoroethylene (PTFE). Other examples of additional binder materials, which may be added to the active composition, include elastomeric polymers such as styrene-butadiene rubber latex. Furthermore, depending upon the application, additional hydrophobic materials may be added to the active composition.

The conductive material may generally be any material which provides for good conductivity within the negative electrode. The conductive material may be chosen from carbon, nickel, copper, copper plated nickel, mixtures thereof, or any other conductive material being compatible with the environment in which the electrode of the present invention is used. While carbon may be available in a variety of forms, its preferable form is a type of graphite or graphite containing composite.

In one embodiment of the present invention, the active catalyst material is incorporated into a negative electrode for a battery. The negative battery electrode comprises a negative electrode active material and a conductive substrate. The negative battery electrode is formed by affixing negative electrode active material onto a conductive substrate. The negative electrode active material may be affixed to the substrate by a number of ways. The electrode may be a paste-type electrode or a non paste-type electrode. The electrode may be formed by applying a paste of the negative electrode active material onto a conductive substrate, compressing a powdered negative electrode active material onto a conductive substrate, or by forming a ribbon of the negative electrode active material and affixing it onto a conductive substrate. The substrate as used in accordance with the present invention may be any electrically conductive support structure that can be used to hold the active composition such as a current collector grid selected from, but not limited to, an electrically conductive mesh, grid, foam, expanded metal, or combinations thereof. The most preferable current collector grid is an electrically conductive mesh having 40 wires per inch horizontally and 20 wires per inch vertically, although other meshes may work equally well. The wires comprising the mesh may have a diameter between 0.005 inches and 0.01 inches, preferably between 0.005 inches and 0.008 inches. This design provides optimal current distribution due to the reduction of the ohmic resistance. Where more than 20 wires per inch are vertically positioned, problems may be encountered when affixing the active material to the substrate. The conductive substrate may be formed of any electrically conductive material and is preferably formed of a metallic material such as a pure metal or a metal alloy. Examples of materials that may be used include nickel, nickel alloy, copper, copper alloy, nickel-plated metals such as nickel-plated copper and copper-plated nickel.

In a paste type battery negative electrode, the active electrode composition is first made into a paste. This may be done by first making the active electrode composition into a paste, and then applying the paste onto a conductive substrate. A paste may be formed by adding water and a “thickener” such as carboxymethyl cellulose (CMC) or hydroxypropylmethyl cellulose (HPMC) to the active composition. The paste would then be applied to the substrate. After the paste is applied to the substrate to form the electrode, the electrode may be sintered. The electrode may optionally be compressed prior to sintering.

To form a battery negative electrode in accordance with the present invention by compressing the powdered active electrode material onto the substrate, the active electrode material is first ground together to form a powder. The powdered active electrode material is then pressed or compacted onto a conductive substrate. After compressing the powdered active electrode material onto the substrate, the electrode may be sintered. To form the electrode in accordance with the present invention using ribbons of the active electrode material, the active electrode material is first is ground into a powder and placed into a roll mill. The roll mill preferably produces a ribbon of the active electrode material having a thickness ranging from 0.018 to 0.02 inches, however, ribbons with other thicknesses may be produced in accordance with the present invention. Once the ribbon of the active electrode material has been produced, the ribbon is placed onto a conductive substrate and rerolled in the roll mill to form the electrode. After being rerolled, the electrode may be sintered.

In another embodiment of the present invention, the active catalytic material is incorporated into a negative electrode for a fuel cell. The negative fuel cell electrode is comprised of a gas diffusion layer, an active material layer, and at least one current collector grid. The gas diffusion layer is comprised of teflonated carbon while the active material layer is comprised of the negative electrode active material in accordance with the present invention.

The layered negative fuel cell electrode promotes uniform hydrogen distribution across the face of the negative fuel cell electrode and absorption of the hydrogen into the active material layer. The gas diffusion layer and the active material layer are placed adjacent and affixed to at least one current collector grid. The gas diffusion layer and the active material layer may be placed between two current collector grids forming a sandwich configuration such that when used inside a fuel cell, the current collector grid in contact with the active material layer is in contact with the electrolyte stream while the current collector grid in contact with the gas diffusion layer is in contact with the hydrogen stream. By using two current collector grids, additional stability is provided to the electrode thereby resulting in a longer lifetime for the electrode. While the preferred embodiment of the invention includes a gas diffusion layer and an active material layer, alternative embodiments of the invention may include additional active material layers or gas diffusion layers to vary the hydrophobicity within the electrode as needed.

The negative fuel cell electrode needs a barrier means to isolate the electrolyte, or wet, side of the hydrogen electrode from the gaseous, or dry, side of the negative fuel cell electrode. A beneficial means of accomplishing this is by inclusion of a hydrophobic component comprising a halogenated organic polymer compound, particularly polytetrafluoroethylene (PTFE) within the gas diffusion layer of the hydrogen electrode to prevent the electrolyte from entering the gas diffusion layer from the active material layer. With this in mind, the gas diffusion layer is primarily a carbon matrix composed of carbon particles coated with polytetrafluoroethylene. The carbon matrix is in intimate contact with a current collector grid which provides mechanical support to the carbon matrix. The carbon particles may be carbon black known as Vulcan XC-72 carbon (Trademark of Cabot Corp.). The gas diffusion layer may contain approximately 20-60 percent by weight polytetrafluoroethylene with the remainder consisting of carbon particles. The use of carbon particles rather than materials like nickel in the gas diffusion layer allows the amount of polytetrafluoroethylene to vary as needed up to 60 weight percent without clogging the pores in the gas diffusion layer. The polytetrafluoroethylene concentration within the gas diffusion layer may also be continually graded from a high concentration at the side of the gas diffusion layer contacting the active material layer to a low concentration at the side of the gas diffusion layer contacting the current collector grid.

The gas diffusion layer of the hydrogen electrode in accordance with the present invention is prepared by at least partially coating carbon particles with polytetrafluoroethylene (PTFE). The carbon particles are preferably carbon black known as Vulcan XC-72 carbon (Trademark of Cabot Corp.), which is well known in the art. The PTFE/carbon mixture contains approximately 20 to 60 percent PTFE by weight. The polytetrafluoroethylene coated carbon particles are then placed in a roll mill. The roll mill produces a ribbon of the gas diffusion layer with a thickness ranging from 0.018 to 0.02 inches as desired.

The active material layer of the hydrogen electrode in accordance with the present invention is prepared by placing the negative electrode active material into a roll mill. The roll mill produces a ribbon of the active material layer having a thickness ranging from 0.018 to 0.02 inches as desired.

Once the ribbons of active material layer and gas diffusion layer have been produced, the layers are placed back to back with one current collector grid placed on each side. The layers and the current collector grids are then rerolled and sintered to form the negative fuel cell electrode.

### EXAMPLE

A negative electrode in accordance with the present invention was formed and tested against a standard misch metal negative electrode. Both electrodes were layered fuel cell electrodes each having a gas diffusion layer and an active material layer. The gas diffusion layer in each electrode is comprised of a mixture containing 60 weight percent polytetrafluoroethylene and 40 weight percent Vulcan XC-72 carbon. The active material layer of the standard negative electrode is comprised of 88 weight percent misch metal, 8.0 weight percent polytetrafluoroethylene, and 4.0 weight percent graphite. The active material layer of the negative electrode in accordance with the present invention comprised 88 weight percent of the highly active, high surface area hydrogen storage material formed by leaching aluminum out of a 50:50 alloy of misch metal and aluminum, 8.0 weight percent polytetrafluoroethylene, and 4.0 weight percent graphite. After the negative electrodes were formed, both electrodes were submerged in an alkaline solution at room temperature. The negative electrode with the highly active, high surface area misch metal was activated in 2.92 hours while the standard misch metal negative electrode was unable to be activated in at room temperature. Upon testing, the activated electrode with the highly active, high surface area misch metal provided an open circuit potential (vs. HgO/Hg reference electrode) of −0.94 V and a potential (vs. HgO/Hg reference electrode) of −0.787 V at a constant current density of 150 mA/cm² at 70° C. The corresponding standard misch metal negative electrode, being unactivated, did not reach its expected open circuit potential and hence could not sustain any current.

The foregoing is provided for purposes of explaining and disclosing preferred embodiments of the present invention. Modifications and adaptations to the described embodiments, particularly involving changes to the shape and design of the negative electrode, the type of active material, and the type of carbon used, will be apparent to those skilled in the art. These changes and others may be made without departing from the scope or spirit of the invention in the following claims.

1. A negative electrode for an alkaline electrochemical cell formed by the process of:
1) forming an alloy including a hydrogen storage material and aluminum;
2) incorporating said alloy into a negative electrode active composition;
3) forming said negative electrode from said negative electrode active composition; and
4) leaching said aluminum from said negative electrode active composition.

2. The negative electrode according to claim 1, wherein said hydrogen storage material and aluminum are present in a ratio ranging from 10:1 to 1:10 within said alloy.

3. The negative electrode according to claim 2, wherein said hydrogen storage material and aluminum are present in a ratio of 1:1 within said alloy.

4. The negative electrode according to claim 1, wherein said hydrogen storage material included in said alloy is selected from the group consisting of Rare-earth/Misch metal alloys, zirconium alloys, titanium alloys, and mixtures or alloys thereof.

5. The negative electrode according to claim 1, wherein said hydrogen storage material included in said alloy is selected from the group consisting of AB type alloys, AB₂ type alloys, AB₅ type alloys, and mixtures thereof.

6. The negative electrode according to claim 1, wherein said negative electrode active composition comprises:
0.0 to 94 weight percent of a hydrogen storage material;
1.0 to 95 weight percent of said alloy;
3.0 to 9.0 weight percent of a binder material; and
2.0 to 5.0 weight percent of a conductive material.

7. The negative electrode according to claim 6, wherein said negative electrode active composition further comprises sodium borohydride.

8. The negative electrode according to claim 6, wherein said conductive material is selected from the group consisting of carbon, nickel, copper, copper plated nickel, and mixtures thereof.

9. The negative electrode according to claim 1, wherein said negative electrode is used in a fuel cell.

10. The negative electrode according to claim 1, wherein said negative electrode is used in a nickel metal hydride battery.

11. A negative electrode for an alkaline electrochemical cell formed by the process of:
1) forming an alloy including a hydrogen storage material and aluminum;
2) leaching said aluminum from said alloy forming a highly active, high surface area hydrogen storage material;
3) incorporating said highly active, high surface area hydrogen storage material into a negative electrode active composition;
4) forming said negative electrode from said negative electrode active composition.

12. The negative electrode according to claim 11, wherein hydrogen storage material and said aluminum are present in a ratio ranging from 10:1 to 1:10 within said alloy.

13. The negative electrode according to claim 12, wherein said hydrogen storage material and said aluminum are present in a ratio of 1:1 within said alloy.

14. The negative electrode according to claim 11, wherein said hydrogen storage material is selected from the group consisting of Rare-earth/Misch metal alloys, zirconium alloys, titanium alloys, and mixtures or alloys thereof.

15. The negative electrode according to claim 11, wherein said hydrogen storage material is selected from the group consisting of AB type alloys, AB₂ type alloys, AB₅ type alloys, and mixtures thereof.

16. The negative electrode according to claim 11, wherein said negative electrode active composition comprises:
0.0 to 94 weight percent of a hydrogen storage material;
1.0 to 95 weight percent of said highly active, high surface area hydrogen storage material;
3.0 to 9.0 weight percent of a binder material; and
2.0 to 5.0 weight percent of a conductive material.

17. The negative electrode according to claim 16, wherein said negative electrode active composition further comprises sodium borohydride.

18. The negative electrode according to claim 16, wherein said conductive material is selected from the group consisting of carbon, nickel, copper, copper plated nickel, and mixtures thereof.

19. The negative electrode according to claim 11, wherein said negative electrode is used in a fuel cell.

20. The negative electrode according to claim 11, wherein said negative electrode is used in a nickel metal hydride battery.

21. An active material composition for a negative electrode comprising:
a highly active, high surface area hydrogen storage material formed by leaching aluminum out of an alloy including a hydrogen storage material and aluminum.

22. The active material composition according to claim 21, wherein said hydrogen storage material and aluminum are present in a ratio ranging from 10:1 to 1:10 within said alloy.

23. The active material composition according to claim 22, wherein said hydrogen storage material and aluminum are present in a ratio of 1:1 within said alloy.

24. The active material composition according to claim 21, wherein said hydrogen storage material is selected from the group consisting of Rare-earth/Misch metal alloys, zirconium alloys, titanium alloys, and mixtures or alloys thereof.

25. The active material composition according to claim 21, wherein said hydrogen storage material is selected from the group consisting of AB type alloys, AB₂ type alloys, AB₅ type alloys, and mixtures thereof.

26. The active material composition according to claim 21, wherein said negative electrode active composition further comprises:
a second hydrogen storage material.

27. The active material composition according to claim 21, wherein said negative electrode active composition further comprises a binder material.

28. The negative electrode according to claim 21, wherein said negative electrode active composition further comprises sodium borohydride.

29. The active material composition according to claim 21, wherein said negative electrode active composition further comprises a conductive material.

30. The negative electrode according to claim 29, wherein said conductive material is selected from the group consisting of carbon, nickel, copper, copper plated nickel, and mixtures thereof.
